(19) United States
(12) Patent Application Publication
(10) Pub. No.: US 2017/0368868 A1
(43) Pub. Date: Dec. 28, 2017

(54) CARD WITH MARBLED VISUAL EFFECT AND ASSOCIATED MANUFACTURING PROCESS

(71) Applicant: Gemalto SA, Meudon (FR)

(72) Inventors: Stephane KARAFOTIS, Meudon (FR); Gilles KODJAGUEUZIAN, MEUDON (FR)

(73) Assignee: Gemalto SA, Meudon (FR)

(21) Appl. No.: 15/537,401

(22) PCT Filed: Dec. 15, 2015
(86) PCT No.: PCT/EP2015/079891

§ 371 Date: Jun. 16, 2017

(30) Foreign Application Priority Data
Dec. 17, 2014 (EP) 14198473.2

(51) Int. Cl. B44F 5/00; B42D 25/351; B42D 25/373; B42D 25/378; B42D 25/455; B32B 27/08; B32B 27/30; B41M 3/00; C09D 11/101; B42D 25/46; G06K 19/077; C09D 11/037; B42D 25/22; B42D 25/23

(52) U.S. Cl. CPC B44F 5/00; G06K 19/07722; B42D 25/351; B42D 25/373; B42D 25/378; B42D 25/455; C09D 11/037; B32B 27/08; B32B 27/304; B41M 3/00; C09D 11/101; B42D 25/46; B42D 25/23; B32B 2255/10; B42D 25/22; B32B 2307/4023; B32B 2307/412; B32B 2307/414; B32B 2307/416; B32B 2425/00; B32B 2451/00; B32B 2255/26

(57) ABSTRACT

The card comprises a first translucent or transparent substrate layer, preferably in PVC, and a second substrate layer, and a cracked layer of ink between the two substrate layers so as to allow the second substrate layer to show through the cracks of the layer of ink. The cracked layer of printing ink comprises mirror-effect ink, that reflects light through the first translucent or transparent substrate layer. The cracking of the layer of ink is achieved when the card is manufactured by laminating it.

This invention relates to the graphics personalisation of multilayer documents, such as cards compliant with ISO 7810, which will be referred to by the generic term ‘cards’ in the text below. The invention relates particularly to a process for manufacturing such cards using lamination so as to give them a marbled visual effect, and the cards obtained thereby.

In order to create a marbled visual effect on a multilayer document, there is a known process for reproducing on each document a marbled pattern made up of at least two colours by means of printing. However, the pattern is identical for each printed document, and its rendering may be affected by the treatment and protection that is subsequently applied to the document.

Another known means for creating a marbled visual effect is to print a first pattern on the document followed by the printing of a second pattern with ink, which, when the solvents contained in it evaporate, forms cracks through which the first pattern can be seen. The marbled visual effect in this case is random but its rendering may also be affected by the treatment and protection applied subsequently to the document. Further, the use of ink comprising solvents that allow the formation of cracks can lead to additional manufacturing costs because a drying time is required for the solvents to evaporate so that the marbled visual effect is satisfactory.

Also, document EP-2705958 describes a card with a random marbled visual effect obtained as a result of the cracking of a layer printed on a substrate and coated with a translucent protective layer, where cracking occurs when all the layers are laminated together. As a result of such cracking of the printed layer, the surface of the substrate becomes locally visible through the cracks, where the whole can be seen through the protective translucent layer. As a result of the patterns printed first on the substrate and the patterns of the layer that is printed in a second stage and cracked randomly by lamination, the required marbled effects are achieved. This process makes it necessary to use printing ink that is specifically suitable for obtaining cracking during lamination. But when compared to the process described above, the thermal and mechanical treatment applied during lamination ensures greater durability of the marbled effect, as it is in a way frozen by the adhesion of the translucent protective layer and unaffected when that layer is laminated.

This invention is aimed at proposing a new process for manufacturing cards that makes it possible to obtain a card with a new visual effect, particularly a durable random marbled effect. It also aims to allow the achievement of the new effect in a simple and economical manner, in steps of a process of the conventional type for making cards such as bank cards, identification cards etc.

With those objectives in mind, the invention is aimed at a process for manufacturing a multilayer card with a marbled effect, where a layer of printing ink suitable for cracking during a lamination stage of the card is applied between a first translucent or transparent substrate layer and a second substrate layer, and said lamination is then carried out so as to make said layer of ink crack.

According to the invention, the process is characterised in that the printing ink layer comprises mirror-effect ink.

Minor-effect ink is ink which, after it is applied on a transparent or translucent substrate, reflects light at least partly through that substrate. A transparent or translucent substrate means a neutral substrate, particularly free of white additive such as that conventionally used to obtain opaque substrates.

In a particular arrangement, the layer of minor-effect ink is applied on the transparent or translucent substrate. The thickness of the applied ink is typically 5 to 10 μm. Greater thickness could lead to low ink resistance to peeling.

In another particular arrangement, the mass of the second substrate layer is dyed. As an alternative, the second substrate layer may be transparent and may optionally comprise a pattern applied on the side of the minor-effect layer. That pattern may particularly be merely an evenly coloured layer of ink.

The two layers of substrate are preferably in PVC, or any other plastic material with a vitreous transition temperature that is substantially equal to or slightly below that of PVC, that is about 75 to 85° C. Indeed, it has been observed by the inventors that ink does not crack if the substrate has a high vitreous transition temperature, particularly if the substrate is polycarbonate.

Preferably, the mirror-effect ink is cured by ultraviolet radiation, and is made up of:
50 to 55% trimethylolpropane triacrylate,
15 to 20% polyolacrylate,
15 to 20% bisphenol A epoxy diacrylate,
5 to 10% aluminium powder, stabilised,
1 to 5% propane-2-ol.

In this ink, acrylates make up the body of the ink or its carrier. The aluminium creates the minor effect, and propanol is used to adjust viscosity.

In a preferable arrangement, the lamination step, which is suitable for cracking the minor-effect ink, comprises the following as a minimum:
a first treatment at temperature ranging from 110 to 150° C. with pressure of 80 to 120N/cm2 for 10 to 20 min,
a second treatment at temperature ranging from 16 to 20° C. with pressure of 180 to 220N/cm² for 10 to 20 min.

In addition to the treatment specific to the invention, the manufacturing of cards could also comprise additional printing operations, typically offset printing, on one of the two sides of the aforementioned assembly comprising the two layers of substrate enclosing the layer of mirror-effect ink, and conventional operations for placing protective layers on the two sides, printed in this manner or not.

The invention is also aimed at making a card with a marbled visual effect, typically obtained by means of the process described above, where said card comprises a first translucent or transparent substrate layer and a second substrate layer, and a layer of cracked printing ink between the two substrate layers that allows the second substrate layer to be visible through the cracks in the layer of ink, characterised in that the cracked layer of printing ink comprises mirror-effect ink, which reflects light through the first translucent or transparent substrate layer.

According to additional particularities:
the thickness of the minor-effect ink is typically 5 to 10 μm.
the mass of the second substrate layer is dyed.
as an alternative, the second substrate layer may be transparent and may optionally comprise a pattern applied on the side of the minor-effect layer.
at least the first transparent substrate layer is made of PVC.
the second substrate layer is also preferably in PVC.

Preferably, the mirror-effect ink is cured by ultraviolet radiation, and is made up of:
50 to 55% trimethylolpropane triacrylate,
15 to 20% polyolacrylate,
15 to 20% bisphenol A epoxy diacrylate,
5 to 10% aluminium powder, stabilised,
1 to 5% propane-2-ol.
the card is printed on one or both sides of the aforementioned assembly comprising the two layers of substrate enclosing the layer of mirror-effect ink,
the card comprises protective layers on both sides, printed in that manner or otherwise.

Other characteristics and benefits will appear in the description below of a card according to the invention, and the method for manufacturing the card.

Reference will be made to the attached drawings, where:

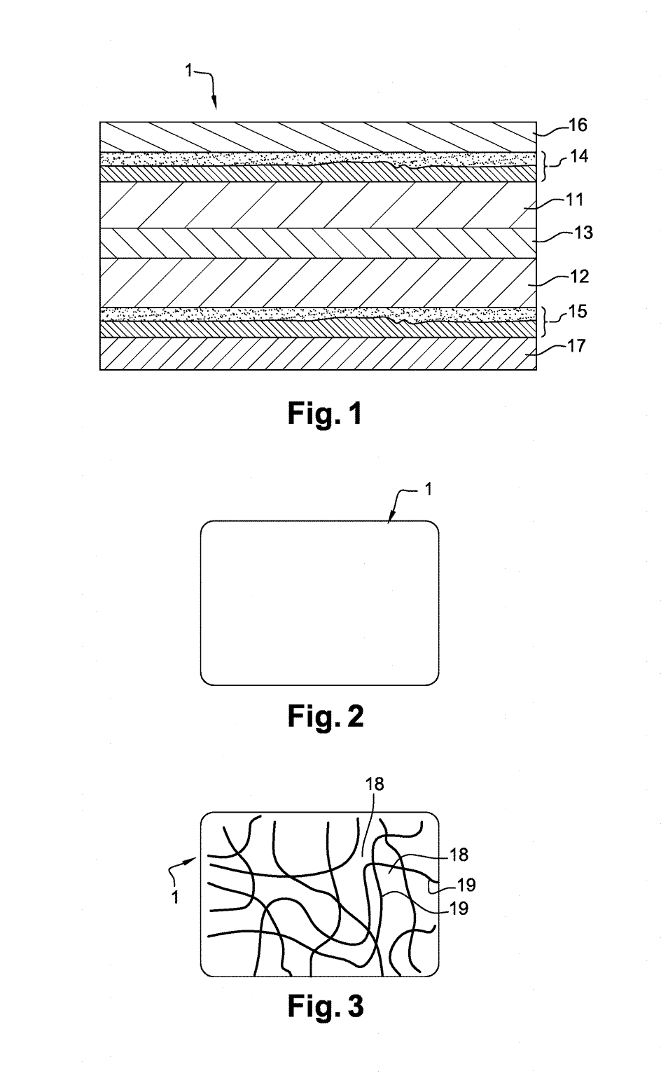

FIG. 1 is a schematic sectional view of a card according to the invention,

FIG. 2 is a view of the card before lamination,

FIG. 3 is a simplified view illustrating the visual appearance of the card after lamination.

FIG. 1 is a sectional view of a card 1 to standard ISO 7810. That card 1 may for example be a bank card for payment, an identification card, an identity card or a magnetic card, a smart card or a Near Field Communication (NFC) card. It is typically about 0.8 to 1.2 mm thick.

Card 1 comprises a first substrate layer 11 in transparent PVC and a second substrate layer 12, which may also be in transparent PVC or mass-dyed or bear a printed pattern, in colour or otherwise, on the side near the first layer.

The card further comprises, between the layers of substrate 11 and 12, a layer of minor-effect ink 13 that is about 5 to 10 μm thick. That layer of ink, the making of which will be detailed later on, is cracked, and the cracks 19 extend randomly as illustrated schematically in FIG. 3, so that the second substrate layer 12 shows through when the card is seen from the side of the first transparent substrate layer 11. In the areas without cracks 18, the mirror-effect ink reflects the incident light passing through the first transparent substrate layer 11. The combination of the cracks 19, which allow the second substrate layer to show through, and such reflection by the areas 18 where the ink is not cracked, results in the marbled effect required for the card.

It must be noted that the cracked layer 13 of mirror-effect ink may extend over the entire surface of the card 1, as illustrated in FIG. 3, but may also extend over only part of the surface. A microchip or an antenna or another electronic component required for the working of the card may be integrated in or between the two layers of substrate 11 and 12.

In the example in FIG. 1, the card further comprises, on the opposite sites of the assembly formed by the two layers of substrate incorporating the film of cracked ink between them, printing, 14, 15, of the ordinary type, serving informational or decorative purposes. The card further comprises, on each side, a transparent or translucent protective layer 16, 17.

The card, as illustrated in FIGS. 1 and 3, is manufactured as follows.

The first substrate layer 11 is prepared in a transparent sheet of PVC.

A layer of minor-effect ink 13 is applied, typically by screen printing, on one side of the first substrate layer 11.

The mirror-effect ink is typically ink containing aluminium, designed to create a mirror effect.

The composition of the ink may be for example:
50 to 55% trimethylolpropane triacrylate,
15 to 20% polyolacrylate,
15 to 20% bisphenol A epoxy diacrylate,
5 to 10% aluminium powder, stabilised,
1 to 5% propane-2-ol.

After the ink is uniformly applied on the first substrate layer, the ink is dried and cured by exposure to UV rays; such exposure does not make the ink crack.

Then the second substrate layer, obtained from a sheet of PVC, preferably transparent but which may also be mass-dyed or pre-printed on the side in contact with the layer of ink, is placed on the dried and cured layer of ink.

Then the information or decorations 14 and 15 are printed and the protective layers 16 and 17 are put in place on each side of the card.

The card is then laminated, with the application of the two steps below:
a first treatment at high temperature of 130° C. with pressure of 100N/cm2 for 15 min,
a second treatment at low temperature of 18° C. with stronger pressure of 200 N/cm2, also for some 15 min,
that sequence of treatments makes the minor-effect ink crack, while assembling the different layers that make up the whole, as is well known elsewhere.

The fact that the minor-effect ink is cracked when the card 1 is laminated by thermal and mechanical treatment ensures greater durability of the marbled effect, as the cracks are in a way frozen by the adhesion of the two substrate layers 11 and 12 on the layer of ink and to each other at the cracks.

Besides, the fact that the cracks 19 are formed during the conventional step of laminating a multilayer card 1 makes it possible to integrate the formation of cracks 19 and thus the marbled visual effect into the standard manufacturing process and thus limit the costs of manufacturing and of creating the visual marbled effect. The costs are all the more limited since the UV exposure stage can also be carried out directly after printing with the minor-effect ink.

1. A process for manufacturing a multilayer card with a marbled effect, where a layer of printing ink suitable for cracking during a lamination stage of the card is applied between a first translucent or transparent substrate layer and a second substrate layer, and said lamination is then carried out so as to make said layer of ink crack,
wherein the printing ink layer comprises mirror-effect ink.

2. The process according to claim 1, wherein the mirror-effect ink layer is applied on the first transparent or translucent substrate layer.

3. The process according to claim 1, wherein the thickness of the ink applied is 5 to 10μιη.

4. The process according to claim 1, wherein the second substrate layer is transparent.

5. The process according to claim 1, wherein the second substrate layer is mass-dyed or has a pattern applied on its side on the side of the mirror-effect ink.

6. The process according to claim 1, wherein the first transparent or translucent substrate layer and the second substrate layer are in PVC.

7. The process according to claim 1, wherein the mirror-effect ink comprises:
50 to 55% trimethylolpropane triacrylate,
15 to 20% polyolacrylate,
15 to 20% bisphenol A epoxy diacrylate,
5 to 10% aluminium powder, stabilised,
1 to 5% propane-2-ol

8. The process according to claim 7, wherein the mirror-effect ink is ink that is cured with ultraviolet radiation.

9. The process according to claim 1, wherein the lamination step, which is suitable for cracking the mirror-effect ink, comprises the following as a minimum:
a first treatment at temperature ranging from 110 to 150° C. with pressure of 80 to 120N/cm2 for 10 to 20 min,
a second treatment at temperature ranging from 16 to 20° C. with pressure of 180 to 220N/cm2 for 10 to 20 min.

10. A card with a marbled visual effect, comprising a first translucent or transparent substrate layer and a second substrate layer, and a layer of cracked printing ink between the two substrate layers that allows the second substrate layer to be visible through the cracks in the layer of ink, wherein the cracked layer of printing ink comprises mirror-effect ink, which reflects light through the first translucent or transparent substrate layer.

11. The card according to claim 10, wherein the thickness of the mirror-effect ink applied is 5μιη to 10μιη.

12. The card according to claim 10, wherein the second substrate layer is transparent.

13. The card according to claim 10, wherein the second substrate layer is mass-dyed or has a pattern applied on its side on the side of the mirror-effect ink.

14. The card according to claim 10, wherein the first transparent substrate layer and the second substrate layer are in PVC.

15. The card according to claim 10, wherein the mirror-effect ink comprises:
50 to 55% trimethylolpropane triacrylate,
15 to 20% polyolacrylate,
15 to 20% bisphenol A epoxy diacrylate,
5 to 10% aluminium powder, stabilised,
1 to 5% propane-2-ol.

16. The card according to claim 10, wherein the card is printed on one or both sides of the assembly comprising the two layers of substrate enclosing the layer of mirror-effect ink.
